(19) United States
(12) Patent Application Publication
(10) Pub. No.: US 2026/0185845 A1
(43) Pub. Date: Jul. 2, 2026

(54) AUTOMATED DETECTION OF MAP ROAD SEGMENTS REQUIRING SPEED LIMIT CORRECTION

(71) Applicant: HERE GLOBAL B.V., EINDHOVEN (NL)

(72) Inventors: ARNOLD SHEYNMAN, NORTHBROOK, IL (US); CORINNE BRADLEY, CHICAGO, IL (US); KYLE JACKSON, CHICAGO, IL (US); SWETHA NUTAKKI, HYDERABAD (IN)

(73) Assignee: HERE GLOBAL B.V., EINDHOVEN (NL)

(21) Appl. No.: 19/002,721

(22) Filed: Dec. 27, 2024

(51) Int. Cl. G01C 21/00; G06V 20/58

(52) U.S. Cl. CPC G01C 21/3807; G01C 21/3841; G06V 20/582

(57) ABSTRACT

A method, system and computer program product for automated detection of map road segments requiring speed limit correction is disclosed. The method includes receiving a request from a quality estimation scheduler; initiating a computer program that automatically: receives a set of map road segments for a given region; receives a speed traffic report for the map road segments during a predefined time interval; identifies a subset of the map road segments that satisfy a predefined traffic speed criteria; further reduces the subset of the map road segments by corroborating with complementary speed limit signs information; compiles a list of map road segments requiring speed limit correction; comparing traffic speeds of the reduced subset with corresponding speed limit signs reported by a map database; and updating map speed limits where required based on the compared traffic speeds.

### TECHNOLOGICAL FIELD

An example aspect of the present disclosure generally relates to estimating quality of speed limits reported by map databases, and more particularly, but without limitation, relates to a system, a method, and a computer program product to for automated detection of map road segments requiring speed limit correction.

### BACKGROUND

Currently, the images received from cameras of Internet connected vehicles as well as recordings collected during real world drive tests are used as ground truth for map speed limits quality estimation. For autonomous driving deployment, quality and freshness of map speed limits play a pivotal role.

It is a challenge to obtain enough data (e.g., images from vehicle cameras) that accurately represents speed limits reported by map. In such cases the discrepancy between map and driving experience causes customer dissatisfaction and complaints

Calculation complexity arises - currently, all road segments for a given region must be processed to estimate quality of reported speed limits. Consequently, a very high amount of information causes the processing pipeline to potentially overload.

### BRIEF SUMMARY

The present disclosure provides a system, a method and a computer program product for automated detection of map road segments requiring speed limit correction, in accordance with various aspects.

Aspects of the disclosure provide a computer implemented method for automated detection of map road segments requiring speed limit correction. The method includes receiving a request from a quality estimation scheduler; initiating a computer program that automatically: receives a set of map road segments for a given region; receives a speed traffic report for the map road segments during a predefined time interval; identifies a subset of the map road segments that satisfy a predefined traffic speed criteria; further reduces the subset of the map road segments by corroborating with complementary speed limit signs information; compiles a list of map road segments requiring speed limit correction; comparing traffic speeds of the reduced subset with corresponding speed limit signs reported by a map database; and updating map speed limits where required based on the compared traffic speeds..

Aspects of the disclosure may provide a system for automated detection of map road segments requiring speed limit correction. The system includes at least one memory configured to store computer executable instructions; and at least one processor configured to execute the computer executable instructions to: receive a request from a quality estimation scheduler; initiate a computer program that automatically: receives a set of map road segments for a given region; receives a speed traffic report for the map road segments during a predefined time interval; identifies a subset of the map road segments that satisfy a predefined traffic speed criteria; further reduces the subset of the map road segments by corroborating with complementary speed limit signs information; compiles a list of map road segments requiring speed limit correction; compare traffic speeds of the reduced subset with corresponding speed limit signs reported by a map database; and update map speed limits where required based on the compared traffic speeds.

Aspects of the disclosure may provide a computer program product comprising a non-transitory computer readable medium having stored thereon computer executable instructions, which when executed by one or more processors, cause the one or more processors to carry out operations for automated detection of map road segments requiring speed limit correction. The operations include receiving a request from a quality estimation scheduler; initiating a computer program that automatically: receives a set of map road segments for a given region; receives a speed traffic report for the map road segments during a predefined time interval; identifies a subset of the map road segments that satisfy a predefined traffic speed criteria; further reduces the subset of the map road segments by corroborating with complementary speed limit signs information; compiles a list of map road segments requiring speed limit correction; comparing traffic speeds of the reduced subset with corresponding speed limit signs reported by a map database; and updating map speed limits where required based on the compared traffic speeds.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF THE DRAWINGS

Having thus described certain aspects of the disclosure in general terms, reference will now be made to the accompanying drawings, which are not necessarily drawn to scale, and wherein:

FIGS. 1a-d illustrates an example flow of information processing for a system for automated detection of map road segments requiring speed limit correction, in accordance with an example aspect.

FIG. 2 illustrates a schematic diagram of a network environment 100 of a system 202 for automated detection of map road segments requiring speed limit correction, in accordance with an example aspect;

FIG. 3 illustrates a block diagram of the system for automated detection of map road segments requiring speed limit correction, in accordance with an example aspect;

FIG. 4 illustrates an example map or geographic database for use by the system for for automated detection of map road segments requiring speed limit correction, in accordance with an example aspect; and

FIG. 5 illustrates a flowchart 400 for acts taken in an exemplary method for automated detection of map road segments requiring speed limit correction, in accordance with an aspect.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

For purposes of this disclosure, though not limiting or exhaustive, “vehicle” refers to standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle (AV) may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one aspect, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

The volume of data collected on road segments increases enormously every year as more roads are built, more vehicles are driven upon these roads, more vehicle probe data is collected and updated in real-time and historically. With this growing data volume, it becomes difficult to obtain enough quality data (e.g., images from vehicle cameras) that accurately represents speed limits reported by map databases maintained by various entities. In such cases the discrepancy between map data and driving experience causes customer dissatisfaction and complaints when the mismatch becomes noticeable or inconvenient.

Updating map databases often requires a full set of road segments to be compared with vehicle camera information for a given region to estimate the quality of reported speed limits. Such computational complexity and processing time can become overwhelming and delay updates to map databases because of the volume of the computational load.

The disclosed system and method for automated detection of map road segments requiring speed limit correction introduces pre-processing of a full set of road segments, reported vehicle probe data and a set of speed limit criteria to produce a reduced set of road segments. This reduced set of road segments may then be more manageable to compare with vehicle camera information about speed limit information, in an aspect, so that a list of road segments requiring updating can be produced. This list of road segments may then be used to update maps of speed limits in map databases, in an aspect according to the disclosure.

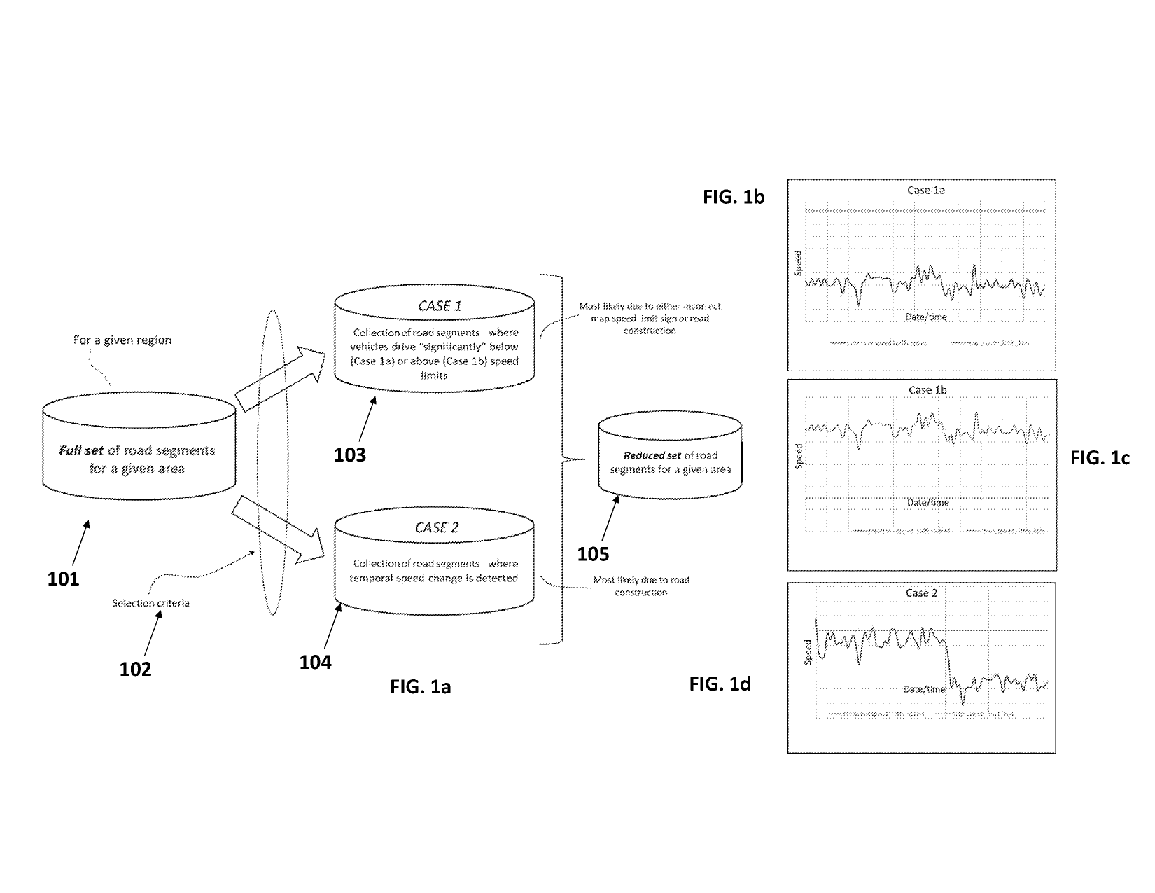

FIG. 1a illustrates a schematic flow of a disclosed computer-implemented method for automated detection of map road segments requiring speed limit correction. In an aspect, in response to receiving a request from a quality estimation scheduler, the disclosed method may initiate a computer program that automatically receives a set of map road segments for a given region (block 101). In an aspect, the set of map road segments may be a full set of map road segments for a given region, which may include a large number of map road segments depending on the size and complexity of the region or density of road features.

In an aspect, the method may receive a set of selection criteria (block 102), such as predefined traffic speed criteria to be applied to the set of map road segments. Such predefined traffic speed criteria may define speed limits for given conditions, such as highway speeds, rural road speeds, interstate, state roads, construction areas or other predefined traffic speed criteria.

In an aspect of the disclosure, the disclosed system may receive a speed traffic report for the map road segments during a predefined time interval. The speed traffic report may be based on real-time vehicle probe data collected from vehicles traveling on segments of the map road segments.

In an aspect, the disclosed system may identify a subset(s) of the map road segments that satisfy a predefined traffic speed criteria (block 103, 104). As illustrated in FIG. 1a, block 103 may represent a case (case 1) where a collection of road segments are identified where vehicles drive “significantly” below (case 1a, shown in FIG. 1b) or above (case 1b , shown in FIG. 1c) speed limits in the given region for the predetermined time period.

In another aspect, block 104 may represent a case 2 may arise where a collection of road segments is detected where a temporal speed change is detected – a shift in speed that exhibits a displaced mean or median speed compared to an earlier time period. This may be seen in FIG. 1d. In this case 2, this situation may arise due to road construction.

Based on these cases, in block 105, the disclosed system may further reduce the subset of the map road segments by corroborating with complementary speed limit signs information. In an aspect, the complementary speed limit signs information may be collected from images taken by cameras disposed upon the vehicles along with the vehicle probe data. In another aspect, the the complementary speed limit signs information may be collected from stationary road-side cameras, cameras positioned on overpasses or towers, aerial cameras such as from unmanned aerial vehicles or aircraft.

In order to identify roadways with potential incorrect speed limit information in the map database, the disclosed system may analyze traffic speed information (including, in an aspect, historical probe speed) to search for statistically-significant changes in speed over time or as compared to the speeds in the map database.

The result will be a small subset of roadways that can be investigated using camera sensor data.

Analytically, the selection criteria may be represented as follows:
Case 1a) “Map Speed Limit Too Fast” : MeanTrafficSpeed( RecentWeeks ) <= Map_Speed_Limit * α (during overnight hours);
Case 1b) “Map Speed Limit Too Slow”: MeanTrafficSpeed( RecentWeeks ) >= Map_Speed_Limit * γ (during daytime hours);
Case 1c “Temporal Speed Change” : ABS( MeanTrafficSpeed( RecentWeeks ) – MeanTrafficSpeed( OlderWeeks ) ) >= δ kph.

Examples of possible parameter value represented above include, but are not limited to:
α = 0.75;
γ = 1.25;
δ = 10
Overnight hours: 1am-4am local time;
Daytime hours: 8am-6pm local time;
“Recent Weeks”: The most recent 3 weeks;
“Older Weeks”: The 7 weeks preceding the most recent 3 weeks.

In one aspect of the disclosure, only the real-time probe data is used for reported traffic speed calculation.

After further reducing the subset of the map road segments by corroborating with complementary speed limit signs information, the disclosed system may compile a list of map road segments requiring speed limit correction.

In an aspect, the disclosed system may compare traffic speeds of the reduced subset with corresponding speed limit signs reported by a map database.

In an aspect, the disclosed system may update map speed limits where required based on the compared traffic speeds.

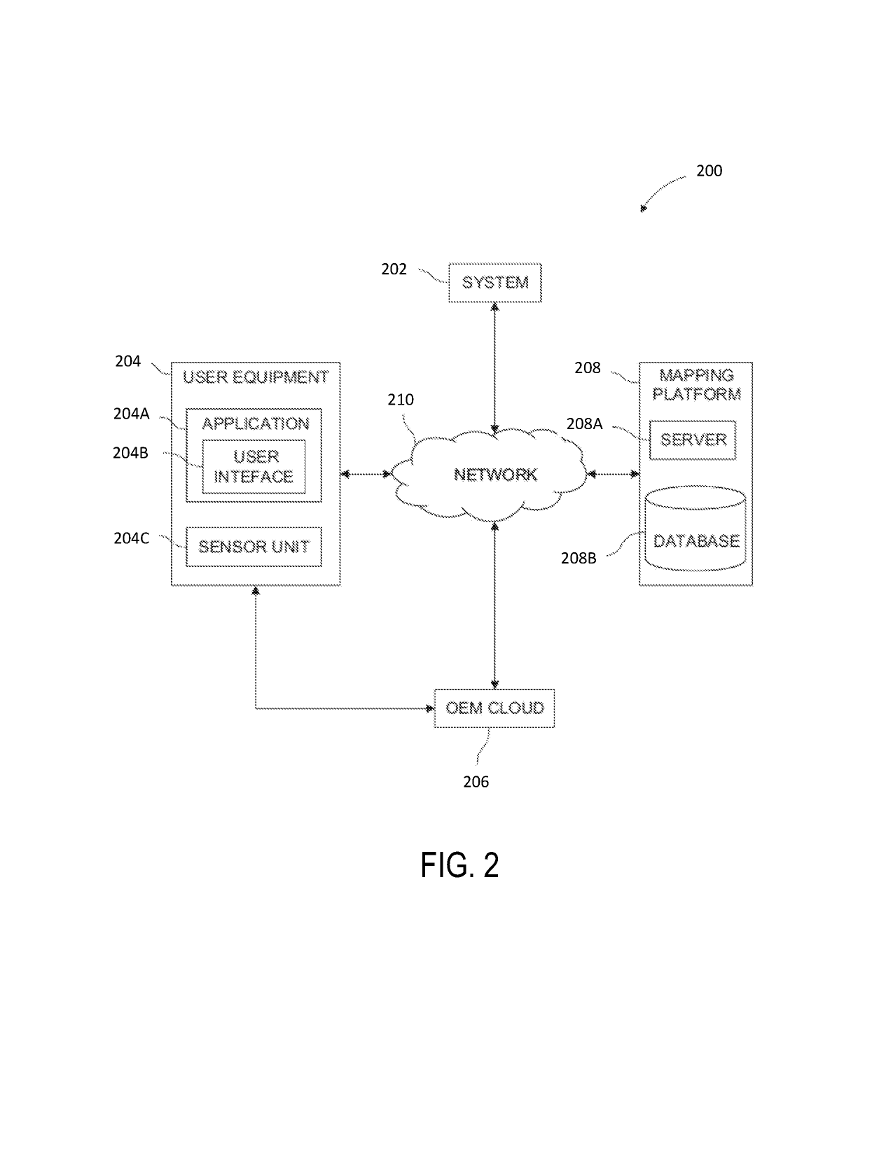

FIG. 2 illustrates a schematic diagram of a network environment 200 of a system 202 for automated detection of map road segments requiring speed limit correction, in accordance with an example aspect. The system 202 may be communicatively coupled with, a user equipment (UE) 204, an OEM cloud 206, a mapping platform 208, via a network 210. The UE 204 may be a vehicle electronics system, onboard automotive electronics/computers, a mobile device such as a smartphone, tablet, smart watch, smart glasses, laptop, wearable device or other UE platforms known to one of skill in the art. The mapping platform 208 may further include a server 208A and a database 208B. The user equipment includes an application 204A, a user interface 204B, and a sensor unit 204C. Further, the server 208A and the database 208B may be communicatively coupled to each other.

The system 202 may comprise suitable logic, circuitry, interfaces and code that may be configured to process the sensor data obtained from the UE 204 for speed, traffic, road and weather conditions in a region, that may be used to assist a user or driver for automated detection of map road segments requiring speed limit correction. Such features can also include historical and real-time vehicle probe data, weather reports, congestion reports, traffic and construction reports, or a combination thereof.

The system 202 may be communicatively coupled to the UE 204, the OEM cloud 206, and the mapping platform 208 directly via the network 210. Additionally, or alternately, in some example aspects, the system 202 may be communicatively coupled to the UE 204 via the OEM cloud 206 which in turn may be accessible to the system 202 via the network 210.

All the components in the network environment 100 may be coupled directly or indirectly to the network 210. The components described in the network environment 100 may be further broken down into more than one component and/or combined together in any suitable arrangement. Further, one or more components may be rearranged, changed, added, and/or removed. Furthermore, fewer or additional components may be in communication with the system 202, within the scope of this disclosure.

The system 202 may be embodied in one or more of several ways as per the required implementation. For example, the system 202 may be embodied as a cloud-based service or a cloud-based platform. As such, the system 202 may be configured to operate outside the UE 204. However, in some example aspects, the system 202 may be embodied within the UE 204. In each of such aspects, the system 202 may be communicatively coupled to the components shown in FIG. 2 to carry out the desired operations and wherever required modifications may be possible within the scope of the present disclosure.

The UE 204 may be a vehicle electronics system, onboard automotive electronics/computers, a mobile device such as a smartphone, tablet, smart watch, smart glasses, laptop, wearable device and the like that is portable in itself or as a part of another portable/mobile object, such as, a vehicle known to one of skill in the art. The UE 204 may comprise a processor, a memory and a network interface. The processor, the memory and the network interface may be communicatively coupled to each other. In some example aspects, the UE 204 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example aspects, the UE 204 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the UE 204. Additional, different, or fewer components may be provided. For example, the UE 204 may be configured to execute and run mobile applications such as a messaging application, a browser application, a navigation application, and the like. In accordance with an aspect, the UE 204 may be directly coupled to the system 202 via the network 210. For example, the UE 204 may be a dedicated vehicle (or a part thereof) for gathering data for development of the map data in the database 208B. In some example aspects, the UE 204 may be coupled to the system 202 via the OEM cloud 206 and the network 210. For example, the UE 204 may be a consumer mobile phone (or a part thereof) and may be a beneficiary of the services provided by the system 202. In some example aspects, the UE 204 may serve the dual purpose of a data gatherer and a beneficiary device. The UE 204 may be configured to provide sensor data to the system 202. In accordance with an aspect, the UE 204 may process the sensor data for information that may be used for automated detection of map road segments requiring speed limit correction, such as weather, traffic conditions, construction, vehicle probe data, etc. Further, in accordance with an aspect, the UE 204 may be configured to perform processing related to automated detection of map road segments requiring speed limit correction..

The UE 204 may include the application 204A with the user interface 204B to access one or more applications. The application 204B may correspond to, but not limited to, map related service application, navigation related service application and location-based service application. In other words, the UE 204 may include the application 204A with the user interface 204B. The user interface 204B may be a dedicated user interface configured to traffic and road conditions to the user. The user interface 204B may be in the form of a map depicting regions with favorable or unfavorable traffic and routing options, according to aspects of the disclosure.

The sensor unit 204C may be embodied within the UE 204. The sensor unit 204C comprising one or more sensors may capture sensor data, in a certain geographic location. In accordance with an aspect, the sensor unit 204C may be built-in, or embedded into, or within interior of the UE 204. The one or more sensors (or sensors) of the sensor unit 204C may be configured to provide the sensor data comprising location data associated with a location of a user. In accordance with an aspect, the sensor unit 204C may be configured to transmit the sensor data to an Original Equipment Manufacturer (OEM) cloud. Examples of the sensors in the sensor unit 204C may include, but not limited to, a microphone, a camera, an acceleration sensor, a gyroscopic sensor, a LIDAR sensor, a proximity sensor, and a motion sensor.

The sensor data may refer to sensor data collected from a sensor unit 204C in the UE 204. In accordance with an aspect, the sensor data may be collected from a large number of mobile phones. In accordance with an aspect, the sensor data may refer to the point cloud data. The point cloud data may be a collection of data points defined by a given coordinates system. In a 3D coordinates system, for instance, the point cloud data may define the shape of some real or created physical objects. The point cloud data may be used to create 3D meshes and other models used in 3D modelling for various fields. In a 3D Cartesian coordinates system, a point is identified by three coordinates that, taken together, correlate to a precise point in space relative to a point of origin. The LIDAR point cloud data may include point measurements from real-world objects or photos for a point cloud data that may then be translated to a 3D mesh or NURBS or CAD model. In accordance with an aspect, the sensor data may be converted to units and ranges compatible with the system 202, to accurately receive the sensor data at the system 202. Additionally, or alternately, the sensor data of a UE 204 may correspond to movement data associated with a user of the user equipment. Without limitations, this may include motion data, position data, orientation data with respect to a reference and the like.

The mapping platform 208 may comprise suitable logic, circuitry, interfaces and code that may be configured to store map data associated with a geographic area in the region of interest related to geographic or other physical features that may assist in navigation and route selection for the user. The map data may include traffic features and include historical (or static) traffic features such as road layouts, pre-existing road networks, business, educational and recreational locations, POI locations, historical and real-time weather conditions in the region or a combination thereof. The server 208A of the mapping platform 208 may comprise processing means and communication means. For example, the processing means may comprise one or more processors configured to process requests received from the system 202 and/or the UE 204. The processing means may fetch map data from the database 208B and transmit the same to the system 202 and/or the UE 204 in a suitable format. In one or more example aspects, the mapping platform 208 may periodically communicate with the UE 204 via the processing means to update a local cache of the map data stored on the UE 204. Accordingly, in some example aspects, map data may also be stored on the UE 204 and may be updated based on periodic communication with the mapping platform 208.

In an aspect, the map data may include, and the database 208B of the mapping platform 208 may store real-time, dynamic data about features for automated detection of map road segments requiring speed limit correction. For example, real-time data may be collected for vehicle probe data, weather reports, congestion reports, traffic and construction reports or a combination thereof. Other data records may include computer code instructions and/or algorithms for executing a trained machine learning model that is capable of automated detection of map road segments requiring speed limit correction.

The database 208B of the mapping platform 208 may store map data of one or more geographic regions that may correspond to a city, a province, a country or of the entire world. The database 208B may store point cloud data collected from the UE 204. The database 208B may store data such as, but not limited to, node data, road segment data, link data, point of interest (POI) data, link identification information, and heading value records. The database 208B may also store cartographic data, routing data, and/or maneuvering data. According to some example aspects, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities for identifying location of building.

Optionally, the database 208B may contain path segment and node data records, such as shape points or other data that may represent raised features and vehicle speed control indications, links or areas in addition to or instead of the vehicle road record data. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 208B may also store data about the POIs and their respective locations in the POI records. The database 208B may additionally store data about places, such as cities, towns, or other communities, and other geographic features such as bodies of water, and mountain ranges. Such place or feature data can be part of the POI data or can be associated with POIs or POI data records (such as a data point used for displaying or representing a position of a city). In addition, the database 208B may include event data (e.g., traffic incidents, construction activities, scheduled events, unscheduled events, accidents, diversions etc.) associated with the POI data records or other records of the database 208B. Optionally or additionally, the database 208B may store 3D building maps data (3D map model of objects) of structures, topography and other visible features surrounding roads and streets, including raised features on the roads.

The database 208B may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the UE 204. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the database 208B may be a master geographic database, but in alternate aspects, the database 208B may be embodied as a client-side map database and may represent a compiled navigation database that may be used in or with end user devices (such as the UE 204) to provide navigation and/or map-related functions. In such a case, the database 208B may be downloaded or stored on the end user devices (such as the UE 204).

The network 210 may comprise suitable logic, circuitry, and interfaces that may be configured to provide a plurality of network ports and a plurality of communication channels for transmission and reception of data, such as the sensor data, map data from the database 208B, etc. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 210 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 210 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) networks (for e.g. LTE-Advanced Pro), 5G New Radio networks, ITU-IMT 2020 networks, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The system, apparatus, method and computer program product described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, method and computer program product configured to determine automated detection of map road segments requiring speed limit correction may similarly be embodied by the same or different server, computer workstation, distributed network of computing devices, personal computer, or other type of computing device.

Alternatively, the system, apparatus, method and computer program product may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

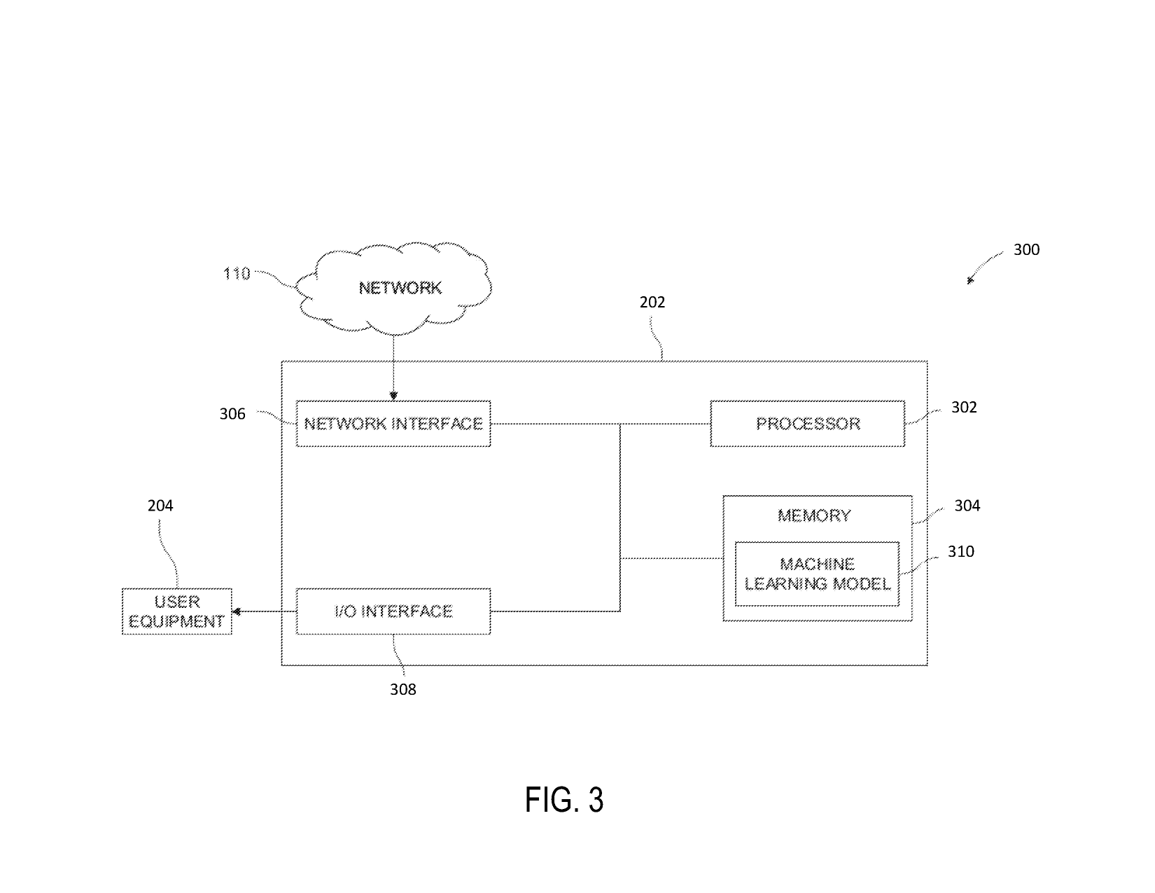

FIG. 3 illustrates a block diagram 300 of the system 302, exemplarily illustrated in FIG. 3, for automated detection of map road segments requiring speed limit correction, in accordance with an example aspect. FIG. 3 is described in conjunction with elements from FIG. 2.

As shown in FIG. 3, the system 302 may comprise a processing means such as a processor 302, storage means such as a memory 304, a communication means, such as a network interface 306, an input/output (I/O) interface 308, and a machine learning model 310. The processor 302 may retrieve computer executable instructions that may be stored in the memory 304 for execution of the computer executable instructions. The system 302 may connect to the UE 204 via the I/O interface 308. The processor 302 may be communicatively coupled to the memory 304, the network interface 306, the I/O interface 308, and the machine learning model 310.

The processor 302 may comprise suitable logic, circuitry, and interfaces that may be configured to execute instructions stored in the memory 304. The processor 302 may obtain sensor data associated automated detection of map road segments requiring speed limit correction. The sensor data may be captured by one or more UE, such as the UE 204. The processor 302 may be configured for automated detection of map road segments requiring speed limit correction. The processor 302 may be further configured to determine, using a trained machine learning model in conjunction with ground truth of the region, automated detection of map road segments requiring speed limit correction, where the ground truth of a region comprises current features of a link and speed limits captured by vehicle cameras, for example.

Examples of the processor 302 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits. The processor 302 may implement a number of processor technologies known in the art such as a machine learning model, a deep learning model, such as a recurrent neural network (RNN), a convolutional neural network (CNN), and a feed-forward neural network, or a Bayesian model. As such, in some aspects, the processor 302 may include one or more processing cores configured to perform independently. A multi-core processor may enable multiprocessing within a single physical package.

Additionally, or alternatively, the processor 302 may include one or more processors configured in tandem via the bus to enable independent execution of instructions, pipelining and/or multithreading. Additionally, or alternatively, the processor 302 may include one or processors capable of processing large volumes of workloads and operations to provide support for big data analysis. However, in some cases, the processor 302 may be a processor specific device (for example, a mobile terminal or a fixed computing device) configured to employ an aspect of the disclosure by further configuration of the processor 302 by instructions for performing the algorithms and/or operations described herein.

In some aspects, the processor 302 may be configured to provide Internet-of-Things (IoT) related capabilities to users of the UE 204 disclosed herein. The IoT related capabilities may in turn be used to provide smart city solutions by providing real time weather and road updates, big data analysis, and sensor-based data collection for providing navigation and charging locations near critical areas. The environment may be accessed using the I/o interface 308 of the system 202 disclosed herein.

The memory 304 may comprise suitable logic, circuitry, and interfaces that may be configured to store a machine code and/or instructions executable by the processor 302. The memory 304 may be configured to store information including processor instructions for training the machine learning model. The memory 304 may be used by the processor 302 to store temporary values during execution of processor instructions. The memory 304 may be configured to store different types of data, such as, but not limited to, sensor data from the UE 204. Examples of implementation of the memory 304 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 306 may comprise suitable logic, circuitry, and interfaces that may be configured to communicate with the components of the system 102 and other systems and devices in the network environment 200, via the network 210. The network interface 306 may communicate with the UE 204, via the network 210 under the control of the processor 302. In one aspect, the network interface 306 may be configured to communicate with the sensor unit 204C disclosed in the detailed description of FIG. 2. In an alternative aspect, the network interface 306 may be configured to receive the sensor data from the OEM cloud 206 over the network 210 as described in FIG. 2. In some example aspects, the network interface 306 may be configured to receive location information of a user associated with a UE (such as, the UE 204), via the network 210. In accordance with an aspect, a controller of the UE 204 may receive the sensor data from a positioning system (for example: a GPS based positioning system) of the UE 204. The network interface 306 may be implemented by use of known technologies to support wired or wireless communication of the system 202 with the network 210. Components of the network interface 206 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/o interface 308 may comprise suitable logic, circuitry, and interfaces that may be configured to operate as an I/O channel/interface between the UE 204 and different operational components of the system 202 or other devices in the network environment 100. The I/o interface 308 may facilitate an I/O device (for example, an I/O console) to receive an input (e.g., sensor data from the UE 204 for a time duration) and present an output to one or more UE (such as, the UE 204) based on the received input. In accordance with an aspect, the I/o interface 308 may obtain the sensor data from the OEM cloud 206 to store in the memory 202. The I/o interface 308 may include various input and output ports to connect various I/O devices that may communicate with different operational components of the system 202. In accordance with an aspect, the I/o interface 308 may be configured to output mitigation and/or confirmation of critical areas to a user device, such as, the UE 204 of FIG. 1.

In example aspects, the I/o interface 308 may be configured to provide the data associated with automated detection of map road segments requiring speed limit correction. In accordance with an aspect, a user requesting information in a geographic region may be updated about historical (or static) road features, real-time or historical weather conditions, road conditions, road construction, etc. Examples of the input devices may include, but are not limited to, a touch screen, a keyboard, a mouse, a joystick, a microphone, and an image-capture device. Examples of the output devices may include, but are not limited to, a display, a speaker, a haptic output device or other sensory output devices.

In accordance with an aspect, the processor 302 may train the one or more machine learning models 310 to assist automated detection of map road segments requiring speed limit correction. In an aspect of the disclosure, the processor 302 may predict map road segments requiring speed limit correction, based on the one or more trained machine learning models in conjunction with ground truth of the region, such as measured real-time probe data, speed limit sign information, road conditions, or a combination thereof. In an aspect, a weighted linear regression model may be used to predict map road segments requiring speed limit correction, based on the one or more trained machine learning models in conjunction with ground truth of the region, such as measured real-time probe data, speed limit sign information, road conditions, or a combination thereof. In another aspect, a look-up table may be used for predicting map road segments requiring speed limit correction, based on the one or more trained machine learning models in conjunction with ground truth of the region, such as measured real-time probe data, speed limit sign information, road conditions, or a combination thereof.

In another aspect, a machine learning model, such as the one or more trained machine learning models 310 discussed earlier, may be used to determine automated detection of map road segments requiring speed limit correction. In accordance with an aspect, the trained machine learning models 310 may be trained offline to obtain a classifier model to determine automated detection of map road segments requiring speed limit correction, based on one or more trained machine learning models in conjunction with ground truth of the region, such as measured real-time probe data, speed limit sign information, road conditions, or a combination thereof. For the training of the trained machine learning models 310, different feature selection techniques and classification techniques may be used. The system 202 may be configured to obtain the trained machine learning models 310 and the trained machine learning models 310 may leverage historical information and real-time data for determining automated detection of map road segments requiring speed limit correction, based on one or more trained machine learning models in conjunction with ground truth of the region, such as measured real-time probe data, speed limit sign information, road conditions, or a combination thereof. In one aspect, supervised machine learning techniques may be utilized where ground truth data is used to train the model for different scenarios and then in areas where there is not sufficient ground truth data, the trained machine learning models 310 can be used to predict features or results.

In an aspect, the trained machine learning model 310 may be complemented or substituted with a transfer learning model. The transfer learning model may be used when the contextual factors related to speed limit correction, such as measured real-time probe data, speed limit sign information, road conditions, or a combination thereof are unavailable, sparse, incomplete, corrupted or otherwise unreliable for predicting critical areas in a region. The transfer learning model may then use historical speed limit update recommendations for automated detection of map road segments requiring speed limit correction in a new region.

In accordance with an aspect, various data sources may provide the static and dynamic information for automated detection of map road segments requiring speed limit correction such as aggregations of locations and conditions that contribute to the updates of speed limit information a given link at a given time as an input to the machine learning models 310. Examples of the machine learning models 210 may include, but not limited to, Decision Tree (DT), Random Forest, and Ada Boost. In accordance with an aspect, the memory 304 may include processing instructions for training of the machine learning model 310 with data set that may be real-time (or near real time) data or historical data. In accordance with an aspect, the data may be obtained from one or more service providers.

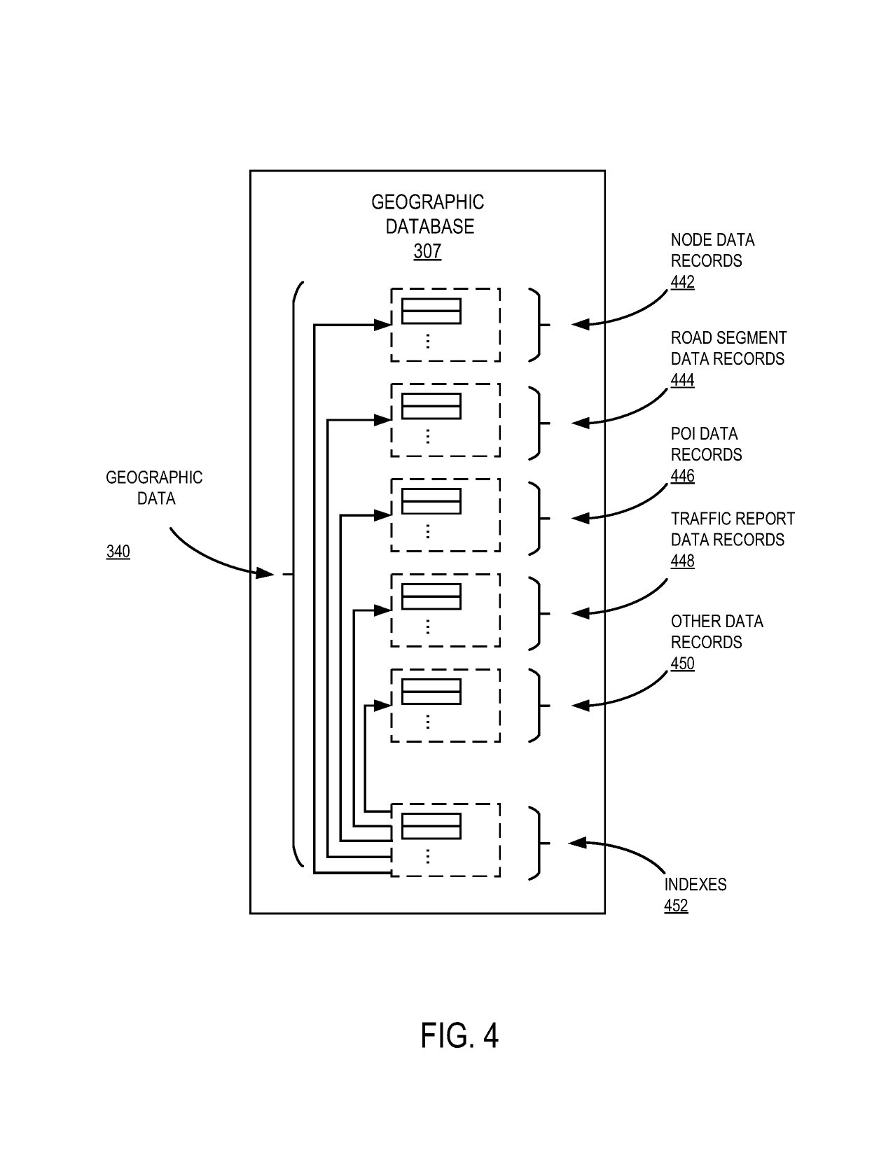

FIG. 4 illustrates an example map or geographic database 407, which may include various types of geographic data 440. The database may be similar to or an example of the database 208B. The data 440 may include but is not limited to node data 442, road segment or link data 444, map object and point of interest (POI) data 446, traffic report data records 448, or the like (e.g., other data records 450 such as traffic data, sidewalk data, road dimension data, building dimension data, vehicle dimension/turning radius data, etc.). Other data records may include computer code instructions and/or algorithms for executing a trained machine learning model that is capable of automated detection of map road segments requiring speed limit correction.

A profile of end user mobility graph and personal activity information may be obtained by any functional manner including those detailed in U.S. Patent No. 9,766,625 and U.S. Patent No. 9,514,651, both of which are incorporated herein by reference. This data may be stored in one of more of the databases discussed above including as part of the traffic report data records 448 in some aspects. This data may also be stored elsewhere and supplied to the system 202 via any functional means.

In one aspect, the following terminology applies to the representation of geographic features in the database 407. A “Node” – is a point that terminates a link, a “road/line segment” – is a straight line connecting two points., and a “Link” (or “edge”) is a contiguous, non-branching string of one or more road segments terminating in a node at each end. In one aspect, the geographic database 407 follows certain conventions. For example, links do not cross themselves and do not cross each other except at a node. Also, there are no duplicated shape points, nodes, or links. Two links that connect each other have a common node.

The geographic database 407 may also include cartographic data, routing data, and/or maneuvering data as well as indexes 452. According to some example aspects, the road segment data records may be links or segments representing roads, streets, or paths, as may be used in calculating a route or recorded route information for determination of automated detection of map road segments requiring speed limit correction. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the geographic database 407 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The geographic database 407 can include data about the POIs and their respective locations in the POI records. The geographic database 407 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The geographic database 407 may be maintained by a content provider e.g., the map data service provider and may be accessed, for example, by the content or service provider processing server. By way of example, the map data service provider can collect geographic data and dynamic data to generate and enhance the map database and dynamic data such as weather- and traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The geographic database 407 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the geographic database 407 may be a master geographic database, but in alternate aspects, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The traffic report data records 448 may include various points of data such as, but not limited to: real-time vehicle probe data for vehicle speed, heading or camera or other sensor data collected by the vehicle probes; traffic conditions, weather conditions, construction or event information; other regional road-related information or a combination thereof.

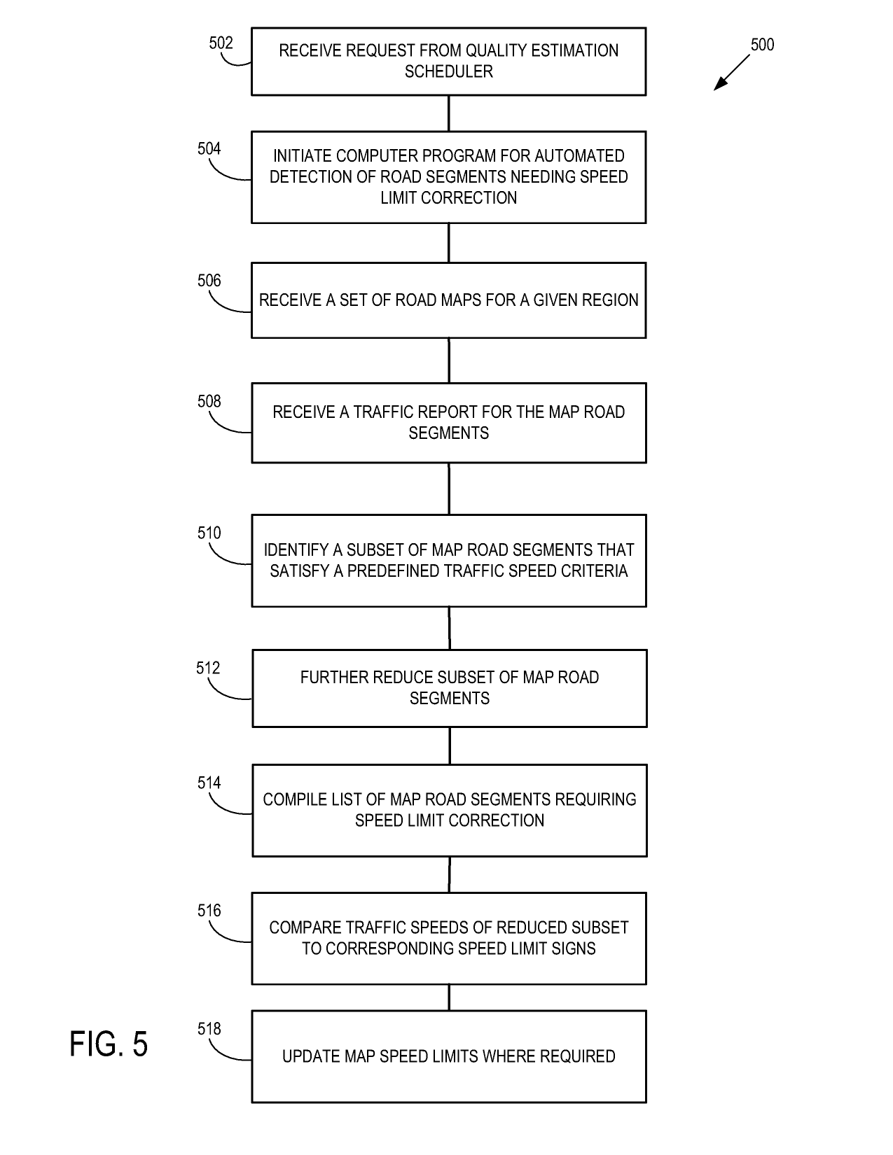

FIG. 5 illustrates a flowchart 500 for acts taken in an exemplary method for automated detection of map road segments requiring speed limit correction, in accordance with an aspect. More, fewer or different steps may be provided. FIG. 5 is explained in conjunction with FIG. 1 to FIG. 4. The control starts at act 502.

At act 502, the system 202 may receive a request from a quality estimation scheduler. In an aspect of the disclosure, the quality estimation scheduler may be an application that reviews, analyzes or updates map information based on updated or revised map road segment information collected by any entity.

At act 504, the system 202 may initiating a computer program to perform acts in furtherance of automated detection of map road segments requiring speed limit correction.

At act 506, the system 202 may automatically receive a set of map road segments for a given region. In an aspect, the map road segments may be links in a region in a map database or other data compilation.

At act 508, the system 202 may automatically receive a speed traffic report for the map road segments during a predefined time interval. In an aspect, the speed traffic report may include speed data collected from real-time probes in communication with one or more vehicles traveling on the set of map road segments.

At act 510, the system 202 may automatically identify a subset of the map road segments that satisfy a predefined traffic speed criteria. In an aspect, the predefined traffic speed criteria may specify speed limits for certain roads, such as rural, interstate, county or POI-specific locations, both historical and real-time or temporary speed limits in a region.

Act 512, the system 202 may automatically further reduce the subset of the map road segments by corroborating with complementary speed limit signs information. In an aspect, the system 202 may determine the complementary speed limit sign information from images of speed limit signs captured by cameras in communication with one or more vehicles traveling on the set of map road segments In an aspect the complementary speed limit signs information may be collected from camera images collected from vehicle probe data, cameras located on road segments or links, cameras positioned on towers or overpasses, aerial cameras or other radar, LiDAR or video information related to speed information.

At act 514, the system 202 may automatically compile a list of map road segments requiring speed limit correction.

At act 516, the system 202 may compare traffic speeds of the reduced subset with corresponding speed limit signs reported by a map database. In an aspect, the system 202 may compare a mean traffic speed calculated from the speed traffic report with the corresponding speed limit sign. In an aspect, the system 202 may compare a mean traffic speed calculated for a recent predetermined time interval with a mean traffic speed calculated for a historical time predetermined time interval. In an aspect, the system 202 may determine potential construction locations where a suspicious speed limit is calculated from the speed traffic report and the corresponding speed limit signs reported by the map database. In an aspect, the suspicious speed limit may be determined when an average daytime speed limit observed from the speed traffic report is less than the corresponding speed limit signs reported by the map database.

At act 518, the system 202 may update map speed limits where required based on the compared traffic speeds.

In some applications, the system 202 may prioritize sampling of data to account for freshness of ground truth sources over statistical interdependency. In an aspect, the system 202 may prioritize temporary speed limits over static speed limits during data sampling and collection. These actions may help identify temporary conditions such as construction or road blockages from inclement weather or road damage.

In an aspect, for sample selection, if a fresh ground truth source is limited (e.g., < 500kms), then all areas having ground truth sources may be selected.

In an aspect, if fresh ground truth source data is largely available (e.g., > 500KMs), then areas having ground truth source and temporary speed limits will be targeted based on potential construction areas from a suspicious speed limit (SSL) model.

In an aspect, areas having ground truth source and static speed limits will be supplemented by an extended 2km from the start and end of potential construction areas selected above. Potential construction areas from SSL may include locations where average daytime speed limit observed from traffic data is less than map coded speed limit. A reported traffic model may output the locations of suspicious speed limit, including, as an example format:
Source of speed limit: Traffic;
Date range for average: Recent 3 weeks from a target date;
Daytime hours: 8am-6pm local time.

This information from the traffic report may assist in updating map database information for the quality estimation scheduler that requested updated map information.

Blocks of the flowchart 500 support combinations of means for performing the specified functions and combinations of operations for performing the specified functions for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions.

Alternatively, the system may comprise means for performing each of the operations described above. In this regard, according to an example aspect, examples of means for performing operations may comprise, for example, the processor 302 and/or a device or circuit for executing instructions or executing an algorithm for processing information as described above.

Although the aforesaid description of FIGS. 1-5 is provided with reference to the sensor data, however, it may be understood that the disclosure would work in a similar manner for different types and sets of data as well. The system 202 may generate/train the machine learning models 210 to evaluate different sets of data at various geographic locations. The update may be provided as a run time update or a pushed update.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an aspect of the present disclosure and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for automated detection of map road segments requiring speed limit correction, the method comprising:
receiving a request from a quality estimation scheduler;
initiating a computer program that automatically:
receives a set of map road segments for a given region;
receives a speed traffic report for the map road segments during a predefined time interval;
identifies a subset of the map road segments that satisfy a predefined traffic speed criteria;
further reduces the subset of the map road segments by corroborating with complementary speed limit signs information;
compiles a list of map road segments requiring speed limit correction;
comparing traffic speeds of the reduced subset with corresponding speed limit signs reported by a map database; and
updating map speed limits where required based on the compared traffic speeds.

2. The method of claim 1, where comparing traffic speeds of the reduced subset with corresponding speed limit signs comprises comparing a mean traffic speed calculated from the speed traffic report with the corresponding speed limit signs.

3. The method of claim 1, where comparing traffic speeds of the reduced subset with corresponding speed limit signs comprises comparing a mean traffic speed calculated for a recent predetermined time interval with a mean traffic speed calculated for a historical time predetermined time interval.

4. The method of claim 1, where the speed traffic report comprises speed data collected from real-time probes in communication with one or more vehicles traveling on the set of map road segments.

5. The method of claim 1, further comprising determining the complementary speed limit sign information from images of speed limit signs captured by cameras in communication with one or more vehicles traveling on the set of map road segments.

6. The method of claim 1, further comprising determining potential construction locations where a suspicious speed limit is calculated from the speed traffic report and the corresponding speed limit signs reported by the map database.

7. The method of claim 6, where the suspicious speed limit is determined when an average daytime speed limit observed from the speed traffic report is less than the corresponding speed limit signs reported by the map database.

8. A system for automated detection of map road segments requiring speed limit correction, comprising:
at least one memory configured to store computer executable instructions; and
at least one processor configured to execute the computer executable instructions to:
receive a request from a quality estimation scheduler;
initiate a computer program that automatically:
receives a set of map road segments for a given region;
receives a speed traffic report for the map road segments during a predefined time interval;
identifies a subset of the map road segments that satisfy a predefined traffic speed criteria;
further reduces the subset of the map road segments by corroborating with complementary speed limit signs information;
compiles a list of map road segments requiring speed limit correction;
compare traffic speeds of the reduced subset with corresponding speed limit signs reported by a map database; and
update map speed limits where required based on the compared traffic speeds.

9. The system of claim 8, where the computer executable instructions to compare traffic speeds of the reduced subset with corresponding speed limit signs comprise computer executable instructions to compare a mean traffic speed calculated from the speed traffic report with the corresponding speed limit signs.

10. The system of claim 8, where the computer executable instructions to compare traffic speeds of the reduced subset with corresponding speed limit signs comprise computer executable instructions to compare a mean traffic speed calculated for a recent predetermined time interval with a mean traffic speed calculated for a historical time predetermined time interval.

11. The system of claim 8, where the speed traffic report comprises speed data collected from real-time probes in communication with one or more vehicles traveling on the set of map road segments.

12. The system of claim 8, further comprising computer executable instructions to determine the complementary speed limit sign information from images of speed limit signs captured by cameras in communication with one or more vehicles traveling on the set of map road segments.

13. The system of claim 8, further comprising computer executable instructions to determine potential construction locations where a suspicious speed limit is calculated from the speed traffic report and the corresponding speed limit signs reported by the map database.

14. The system of claim 13, where the suspicious speed limit is determined when an average daytime speed limit observed from the speed traffic report is less than the corresponding speed limit signs reported by the map database.

15. A computer program product comprising a non-transitory computer readable medium having stored thereon computer executable instructions, which when executed by one or more processors, cause the one or more processors to carry out operations for automated detection of map road segments requiring speed limit correction, the operations comprising:
receiving a request from a quality estimation scheduler;
initiating a computer program that automatically:
receives a set of map road segments for a given region;
receives a speed traffic report for the map road segments during a predefined time interval;
identifies a subset of the map road segments that satisfy a predefined traffic speed criteria;
further reduces the subset of the map road segments by corroborating with complementary speed limit signs information;
compiles a list of map road segments requiring speed limit correction;
comparing traffic speeds of the reduced subset with corresponding speed limit signs reported by a map database; and
updating map speed limits where required based on the compared traffic speeds.

16. The computer program product of claim 15, where the operations for comparing traffic speeds of the reduced subset with corresponding speed limit signs comprise operations for comparing a mean traffic speed calculated from the speed traffic report with the corresponding speed limit signs.

17. The computer program product of claim 15, where the operations for comparing traffic speeds of the reduced subset with corresponding speed limit signs comprise operations for comparing a mean traffic speed calculated for a recent predetermined time interval with a mean traffic speed calculated for a historical time predetermined time interval.

18. The computer program product of claim 15, further comprising operations for determining the complementary speed limit sign information from images of speed limit signs captured by cameras in communication with one or more vehicles traveling on the set of map road segments.

19. The computer program product of claim 15, further comprising operations for determining potential construction locations where a suspicious speed limit is calculated from the speed traffic report and the corresponding speed limit signs reported by the map database.

20. The computer program product of claim 19, where the suspicious speed limit is determined when an average daytime speed limit observed from the speed traffic report is less than the corresponding speed limit signs reported by the map database
